(19) United States
(12) Patent Application Publication
(10) Pub. No.: US 2011/0060623 A1
(43) Pub. Date: Mar. 10, 2011

(54) System and Method for Resource Workflow Scheduling

(75) Inventor: Kevin Jay Neureuter, Churchville, NY (US)

(73) Assignee: Flower City Group

(21) Appl. No.: 12/555,699

(22) Filed: Sep. 8, 2009

(51) Int. Cl. G06Q 10/00; G06F 3/048; G06F 17/30

(52) U.S. Cl. 705/8; 715/772; 715/769; 707/802; 707/E17.044

(57) ABSTRACT

A system and method for resource workflow scheduling providing a resource workflow scheduling interface where a resource is defined along a first axis and time is defined along a second axis. Tasks are represented as movable objects which are scheduled and may be rescheduled according to constraints stored in a database. Tasks that must be scheduled over multiple days are represented as visually and structurally connected objects. Constraints stored in the database comprise rules and restrictions defining the sequence of tasks required to complete a job, the association of tasks to resources, the time a particular resource requires to complete the task, and the date that task must be completed.

### FIELD

This invention relates in general to the field of methods and systems for scheduling, and more particularly to a method and system for providing resource scheduling displays for use in a wide variety of manufacturing environments.

### BACKGROUND OF THE INVENTION

The manufacture of a good often requires many tasks and subtasks using a variety of resources such as machines and processes. Thus, it is necessary for manufacturers to efficiently manage and schedule production resources in order to compete in the marketplace. Customers increasingly require diverse products and needs exist to provide a resource scheduling tool compatible with and flexible to customers ever changing product needs. In manufacturing industries requiring the production of diverse goods, wherein each different project may use a different set of resources, machines, and processes, effectively and efficiently scheduling resource and workflows poses particularly difficult problems. Clearly in these complex scenarios, manufacturing a high volume of various goods at once requires efficient management of production resources.

For the purposes of the present disclosure, a “resource workflow” may be considered as a depiction of a particular resource's scheduled tasks. A resource may be any machine, operation, or process necessary to complete a job, project, or task. A job or project may be considered a sequence of operations, declared as work of a person, a group of persons, an organization of staff, or one or more simple or complex mechanisms. Each job or project may be divided into tasks, each of which must be completed to complete that job or project. Workflow may also be seen as any abstraction of real work, segregated in workshare, work split or other types of ordering. For control purposes, workflow may be a view on real work under a chosen aspect, thus serving as a virtual representation of actual work. The flow being described often refers to a document that is being transferred from one step to another.

As the number, interrelation, and sequence of tasks for manufacturing a product becomes more complex, the importance, and difficulty, of tracking, organizing, scheduling, and evaluating resource workflows increases. In such manufacturing and production environments, project management and resource workflow management empower employees to view schedules uses of a resource and to readily adjust or modify that resource's task or production schedule as necessary. Combining project and production management in a flexible and easy to use display presents particular difficulties in high volume and diverse manufacturing environments.

Existing project management and scheduling tools such as Gantt charts, Project Evaluation and Review Technique (PERT) charts, and Critical Path Method (CPM) analysis assist in scheduling complex production projects requiring many tasks. Existing tools may define the production of a good as a project and provide an efficient production path for that project among various resources required for project completion. These scheduling tools include methods for providing a continuous production path for a particular project or the production of a good. However, existing scheduling tools often do not provide workflow scheduling at the resource level.

In manufacturing industries, it is necessary to schedule a particular resource's workflow, including tasks required by multiple projects. The complexity of modern manufacturing requires workflow scheduling tools that operate according to the time constraints of the projects as a whole. To efficiently manufacture products, managers must be able to schedule, monitor, and change a resource's workflow quickly and easily without increasing a particular goods production time. While project management tools help to provide task scheduling among resources, they often are inadequate for scheduling a particular resource's daily workflow.

Further, existing scheduling tools, such as Gantt charts, tend to employ only a horizontal orientation, where time is defined on the x-axis and a project's tasks are defined on the y-axis, providing one continuous path for a project's completion. For example, a Gantt chart generally appears as a horizontal bar chart showing the time dependency of activities required to complete a task. The horizontal x-axis of the Gantt chart includes a time unit and the vertical y-axis tracks a task required to complete the project wherein horizontal bars graphically represent the time required for each task. Horizontally-oriented charts permit scheduling and displaying a project schedule, but are often difficult to read on a resource workflow level. Production managers are often only concerned with scheduling a particular resource's daily workflow and not the chain of operations associated with that task, but existing scheduling tools do not offer scheduling at the resource and production level. Using existing tools, scheduling or rescheduling a task to a resource workflow according to the constraints of that task's project management plan may be particular difficult or cumbersome.

Cumbersome aspects of horizontally-oriented scheduling displays include problems with making adjustments at the task level and re-deploying a resource consistent with changing constraints in a production schedule. Tasks must be rescheduled due to new customer requirements, manufacturing problems, or simply to improve efficiency and increase resource use-all within the constraints of project and its chain of operations. Visually, horizontally oriented scheduling displays also may be difficult to read at the production level. These horizontal project scheduling displays tend to show one project as a continuous time element, whereas many users require only the condensed workflow of a resource or group of resources for a particular number of days. Further, horizontal project scheduling displays may present limited resource information and waste considerable space. Managers concerned with scheduling a resource's workflow and a production schedule often need information concerning each scheduled task and the resource itself.

Therefore a need has arisen for a scheduling interface which may be used to schedule a resource's daily workflow and schedule tasks at the resource level. A need exists to allow users the flexibility to schedule and reschedule a task to a resource workflow in accordance with the constraints of the tasks project management plan. The scheduling interface must present the resource workflow in a visual manner that allows for the scheduling of a plurality of resources over a plurality of days.

### SUMMARY

In accordance with the disclosed subject matter, a method and system for providing a resource workflow scheduling interface is provided that substantially eliminates or reduces disadvantages and problems associated with previously developed scheduling tools. The present disclosure provides for a resource workflow scheduling interface that presents tasks and the time they take to complete as movable objects called task tickets which are scheduled and may be rescheduled according to constraints stored in a database. The interface may present a particular resource or a plurality of resources' production schedules in a variety of customizable displays to increase scheduling efficiency. Tasks that must be scheduled over multiple days are represented as visually and structurally connected objects. The constraints stored in the database comprise rules and restrictions defining the sequence of tasks required to complete a job, the association of tasks to resources, the time a particular resource requires to complete the task, and the date that task must be completed. The present disclosure also provides for a vertically oriented resource workflow scheduling interface where a resource is defined along the x-axis and time is defined along the y-axis.

A technical advantage of the present disclosure is the ability to schedule tasks at the production level in a method easily understood by the majority of people. However, the axis may be easily reversed. The system allows a task to be scheduled according to its own constraints and deadlines and also in the context of other task's constraints and deadlines. Users responsible for a particular resource are able to view and schedule tasks without knowledge of these constraints, thereby decreasing scheduling confusion and mistakes.

Another technical advantage of the present disclosure is a scheduling interface that provides a resource workflow in a visually concise and readable manner. The workflow is graphically presented to allow the user to quickly identify resource and task scheduling needs. In one embodiment, the vertical orientation of the display provides a user with a comprehensive resource workflow at the production level, such as the representation of task duration for multiple machines on one day, in a compact space without wasting valuable display space. This view is optimal to see how busy a facility or a resource is on a given day at a quick glance. Vertical orientation also allows for many configuration customization options, such as the selection of resources to be viewed and the number of days to view. The display may be vertical or horizontally oriented to make available the variety of configuration customization options. Resources may be selected as a group for view, or all resources in a job's chain of operations may be shown. Further, tasks that have been scheduled by date only and not yet scheduled on the workflow are presented for quick daily workflow scheduling.

Other technical advantages of the present disclosure include an intelligent display which allows a user to configure their view by entering the resolution of their monitor, and in the case of a multiple monitor setup the number and grid setup of monitors. The system then displays an appropriated number of days or resources that will fit on the user's available display space.

Other technical advantages are readily apparent to one skilled in the art from the following FIGUREs, description, and claims.

### BRIEF DESCRIPTIONS OF THE DRAWINGS

For a more complete understanding of the disclosed subject matter and advantages thereof, reference is now made to the following description taken in conjunction with the accompanying drawings in which like reference numerals indicate like features and wherein:

FIG. 1 is a diagram illustrating the functional relationship of the overall system of the present invention;

FIG. 2 is a general flow chart of a resource workflow scheduling method in accordance with the present disclosure;

FIG. 3 is a scheduling interface that is vertically oriented by days and machine over time;

FIG. 4 is an enlarged view of a task ticket from a scheduling interface that is vertically oriented by days and machine over time;

FIG. 5 is a scheduling interface that is vertically oriented by day and a plurality of machines over time;

FIG. 6 is a scheduling interface that is vertically oriented by day and a plurality of machines over time showing the visual representation each days unscheduled task tickets;

FIG. 7 is an enlarged view of a days unscheduled task tickets;

FIG. 8 shows a customization window allowing resources to be selected for viewing on the scheduling interface;

FIG. 9 is an enlarged view of file menu options;

FIG. 10 is an enlarged view of views menu options;

FIG. 11 is an enlarged view of a date selector;

FIG. 12 is an enlarged view of a task ticket overrun onto the following day;

FIG. 13 shows an embodiment of an administration configuration window;

FIG. 14 shows a utility window displaying job information;

FIG. 15 shows a utility window displaying job function information;

FIG. 16 is an enlarged view of a displayed resource information window;

FIG. 17 is an enlarged view of overlapping task tickets;

FIG. 18 is an enlarged view of a valid drag and drop of a task ticket; and

FIG. 19 is an enlarged view of an invalid drag and drop of a task ticket.

### DETAILED DESCRIPTION OF THE SPECIFIC EMBODIMENTS

The following description is not to be taken in a limiting sense, but is made for the purpose of describing the general principles of the present disclosure. The scope of the present disclosure should be determined with reference to the claims. And although described with reference to the printing industry, a person skilled in the art could apply the principles discussed herein to any production or manufacturing environment. Preferred embodiments of the disclosed subject matter are illustrated in the FIGUREs, like numerals being used to refer to like and corresponding parts of the various drawings.

The scheduling methods described herein are designed as a user interface to assist in scheduling a workflow for a resource. In particular, these scheduling methods are applicable to presenting a graphical display for scheduling the workload of a resource. More specifically, in one embodiment the graphical display may be a vertically oriented display. In this disclosure, the term workflow refers to a particular resource's scheduled tasks. Typically, a resource workflow is divided by days, however it may also be divided by employee work shifts, required resource downtime, or by tasks completed. In this disclosure the term vertically oriented refers to a chart where resources are defined along the x-axis and time is defined vertically along the y-axis. The term resource may be a machine or process necessary to complete a task or subtask. The term job refers to the manufacture or production of a product.

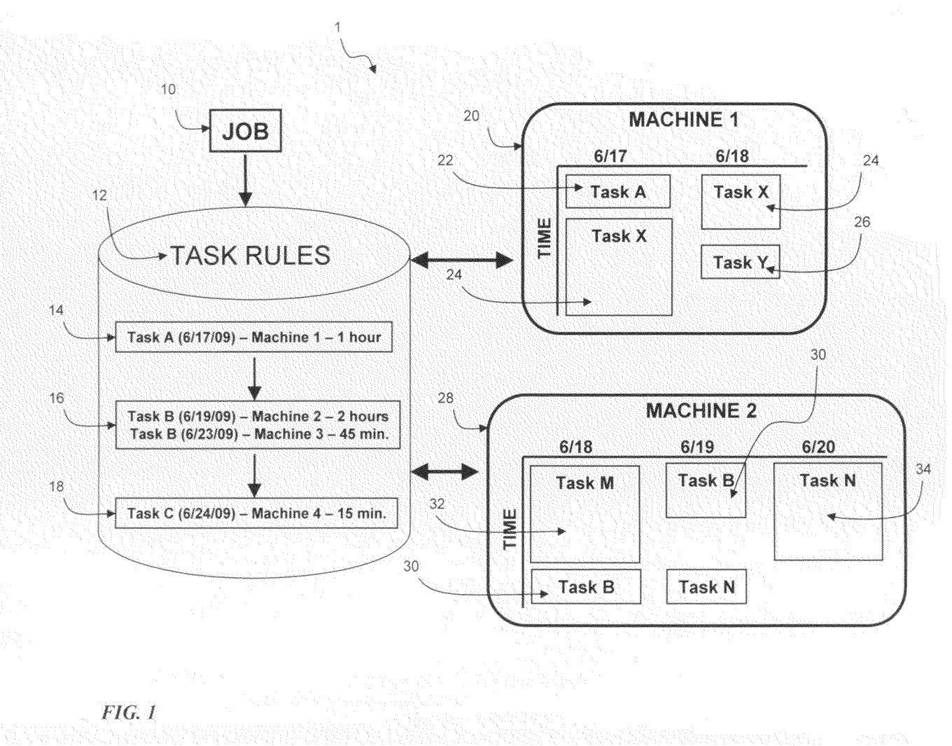

FIG. 1 is a diagram illustrating the functional relationship of overall system 1 of a preferred embodiment of the present invention. Job 10 is the manufacture of a product and may be created or selected from a list of previously predefined jobs. Task rules 12 is a database storing rules, restrictions, and constraints defining a number of jobs, including job 10. According to task rules 12, job 10 has been defined as the sequence of task A 14, task B 16, and task C 18. Machine 1 display 20 and machine 2 display 28 are representations of alternative embodiments of the graphical display of the present disclosure. Machine 1 display 20 displays a vertical orientation of workflow over time of the workflow schedule for two days of machine 1 (x-axis) where the time in each day is defined on the y-axis. Machine 2 display 28 displays a vertical orientation of workflow over time of the workflow schedule for three days of machine 2 (x-axis) where the time in each day is defined on the y-axis. Task rules 12 is integrated with machine 1 display 20 and machine 2 display 28 in order to provide the constraints by which tasks may be scheduled.

Task rules 12 defines job 10 as the sequence of tasks A 14, B 16, and C 18, the date that task must be completed by, the resource that will perform the task, and the length of time that resource takes to complete the task. Task rules 12 restricts how and where a user may schedule a task on machine 1 display 20, machine 2 display 28, and any other display requested by user. As shown, Task A 14 must be completed by Jun. 17, 2009, may be performed by Machine 1 on which it will take one hour to complete. This information is shown as task ticket A 22 on machine 1 display 20. Task ticket A 22 is displayed on Jun. 17, 2009 and its length is proportional to one hour of time. A user is able to manipulate task ticket A 22 according to the constraints stored in task rules 12 in order to more efficiently schedule the production workflow of machine 1. Task B 16 must be completed by Jun. 19, 2009, may be performed by Machine 2 on which it will take two hours to complete or Machine 3 (Machine 3 display is not shown on FIG. 1, however Machine 3 is another machine capable of completing task B 16 and is included in the programming logic for task B 16) on which it will take forty five minutes to complete. This information is shown as task ticket B 30 on machine 2 display 28. Task ticket B 30 is displayed as beginning Jun. 18, 2009 and its length is proportional to two hours of time. A user is able to manipulate task ticket B 30 according to the constraints stored in task rules 12 in order to more efficiently schedule the production workflow of machine 2. Task ticket B 30 is a spillover task ticket where completion of task B beginning on June 18 requires work on June 19. Spillover task tickets, such as task ticket B 30, are shown as visually and structurally (programming logic) connected visual elements that represent one task.

Machine 1 display 20 displays other scheduled tasks required by other jobs, such as task ticket X 24 as a spillover ticket and task ticket Y 26. Also, machine 2 display 28 displays other scheduled tasks required by other jobs, such as task ticket M 32 and task ticket N 34. The resource or resources and number of days are customizable according to a user's needs.

Task rules 12 are data objects stored in a database. The task tickets are virtual objects and may be moved according to the constraints of associated data objects stored in a database. The scheduling display is an interface interface, and may be but is not limited to user interfaces such as a graphical user interface, web user interface, touch user interface, multi screen interface, projection system, mobile device, or scanner system.

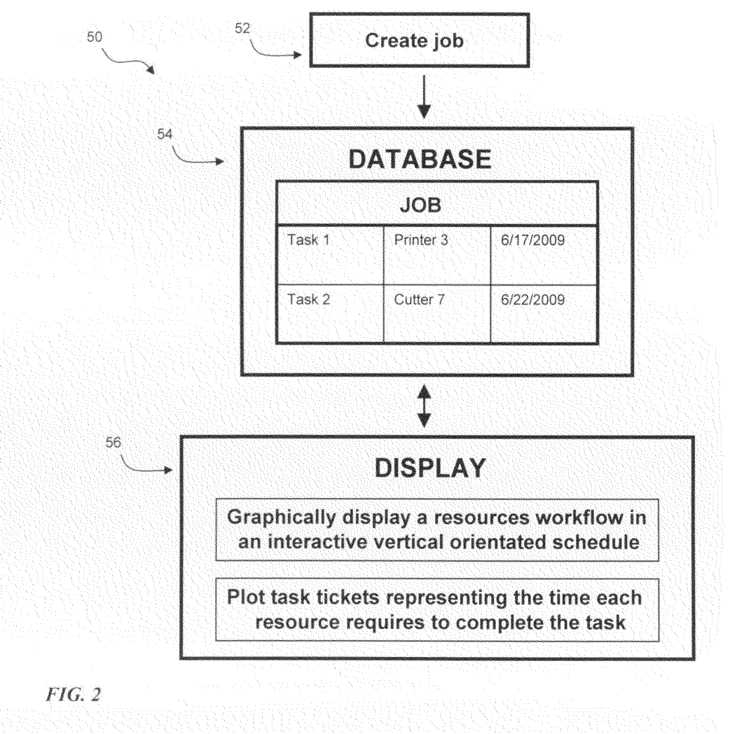

FIG. 2 shows a general flow chart 50 of a resource workflow scheduling method in accordance with the present disclosure. A user must first create a job 52. This may be done by selecting from previously created jobs or by combining stored tasks to create a new job. Database 54 stores data that describes the project. Database 54 is integrated with display 56. Display 56 displays tasks according to the data stored in database 54. Display 56 provides and displays a vertically oriented graphical resource workflow scheduling tool where tasks, as task tickets representing the time a particular resource takes to complete a task, and are plotted on the display.

The stored data includes, among other information, the tasks that make up a job, the sequence those tasks must be completed in, the resources needed to complete each task, the time each resource requires to complete an associated task, and the date a task must be completed. These constraints may be stored in a table and may be formed according to formulas or modeling results. Each constraint associated with a task is created in accordance with the project management plan associated with the job of which that task is a part. This allows the user to easily schedule tasks according to its own deadlines and specifications, but also in the context of many other tasks and their deadlines. Allowing an infinite number of constraints minimizes task scheduling confusion and mistakes in complex and high volume production environments.

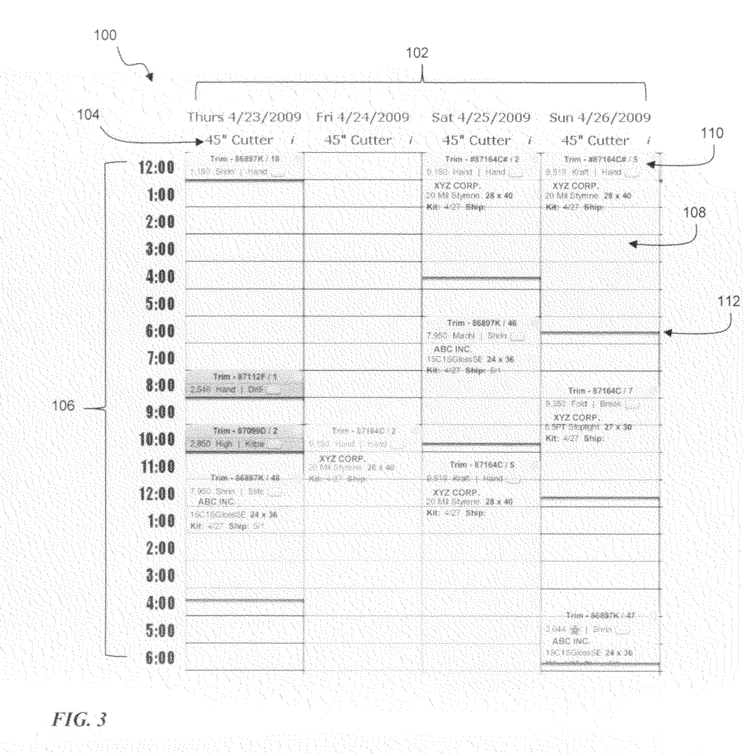

FIG. 3 through FIG. 19 are cropped screenshot captures illustrating embodiments of the vertically oriented scheduling display. The display is user oriented and incorporates many user friendly options to allow for maximum customization. The display allows users to customize many visual and structural aspects of the schedule in order to provide and allow scheduling on the production resource level.

FIG. 3 shows graphic scheduling interface 100 that is vertically oriented by days 102 and machine 104 over time 106. The production workflow of machine 104 is represented by multiple task tickets similar to task ticket 108 corresponding to the time required by machine 104 to complete the task associated with task ticket—task 110 corresponds to task ticket 108. Each task ticket is defined by a visual header and a visual closer. Task time object 108 is defined by task header 110, task closer 112, and the day on which the task will be performed, here Sunday Apr. 26, 2009. Task time object 108 may be visually displayed as a particular color or shade defined by the task rules in order to allow the user to quickly identify that particular task. Each task time object displayed is a virtual object represented in a visually and structurally continuous manner to allow a user to identify the time required to complete the task and schedule a particular resources workflow.

Alternatively, a user may select any number of days 102 to be displayed on the interface. In this embodiment, time 106 is shown in hour increments showing machine 104's available production schedule. Time 106 may be divided alternatively in minute increments and alternatively only display a portion of a particular day's production schedule such as an employee work shift.

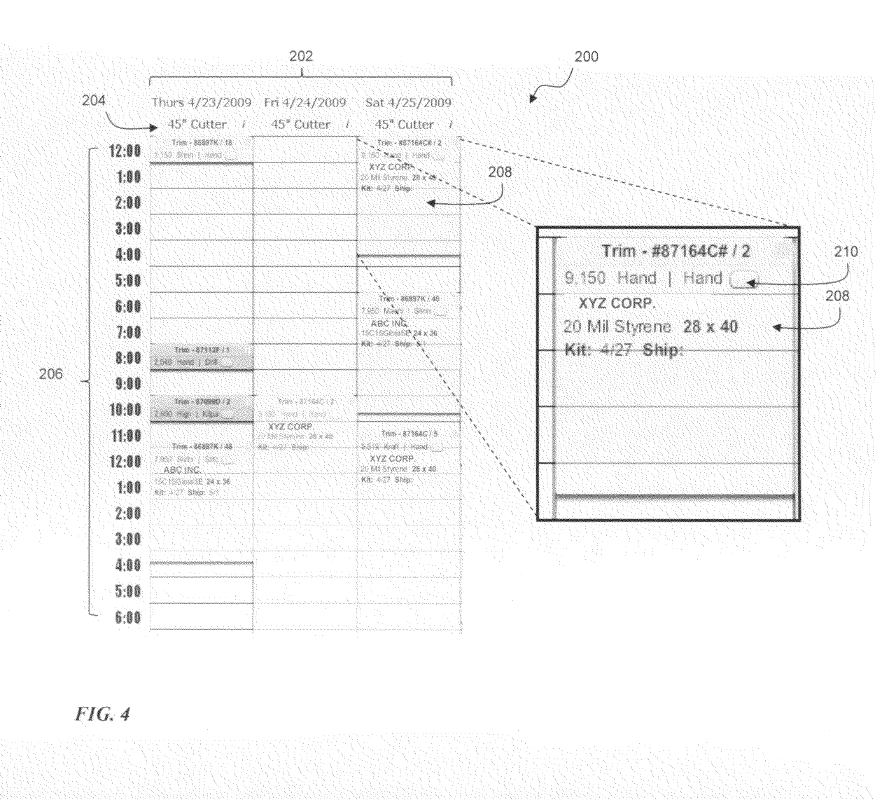

FIG. 4 shows graphic scheduling interface 200 that is vertically oriented by days 202 and machine 204 over time 206 with task ticket 208 enlarged to show the information that may be displayed with task time object 208. Information stored in database such as the job number, detailed information about the job, specific work and machining requirements, and completion dates may be included to assist the user in the task completion. Status identifier 210 displays the completion status of the job by color and may be updated by a user, by time, or by the resource itself through a display machine interface.

As a task ticket is scheduled, it will automatically re-flow to accurately display the projected finish time on the interface and to accommodate the scheduled task ticket on the resource workflow. Changes in machine or operations specifications that affect the duration of a task will also cause the ticket to re-flow.

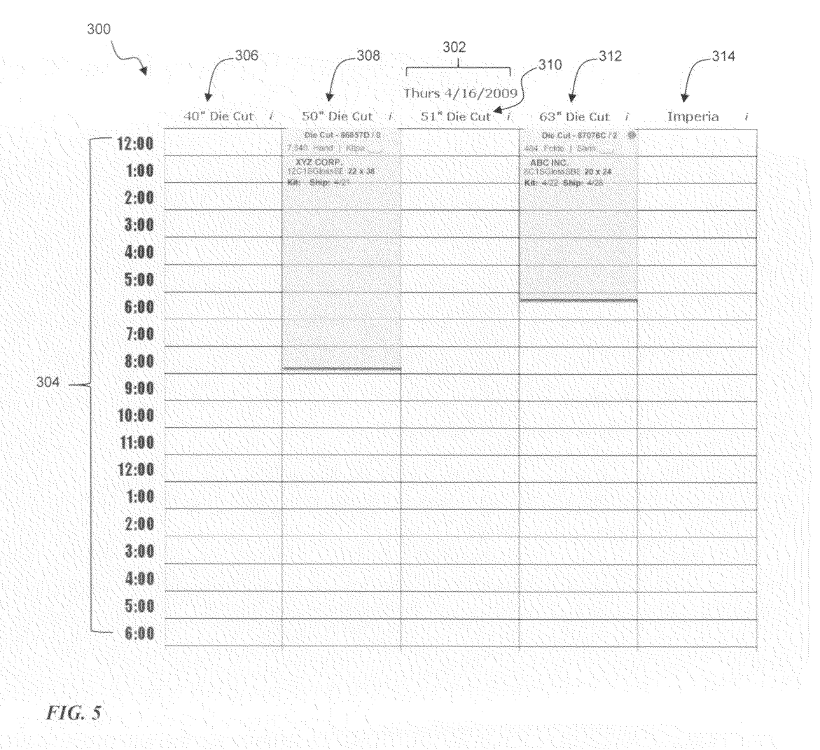

FIG. 5 shows graphic scheduling interface 300 that is vertically oriented by day 302 and a plurality of machines over time 304. In this scheduling view, the user has selected machines to view according to their function. Here, machines 306, 308, 310, 312, and 314 are part of the machine functionality, die cutters, and displayed on the same scheduling interface. Graphically displaying the workflow production schedule vertically allows user to customize the display by functionality. An advantage of the present disclosure is that resources may be grouped and displayed together, or a number of resources may be selected by the user to be displayed on the scheduling interface. This is particularly advantageous if a task may be performed by a number of different resources and the user wishes to schedule that task based on each resources workflow.

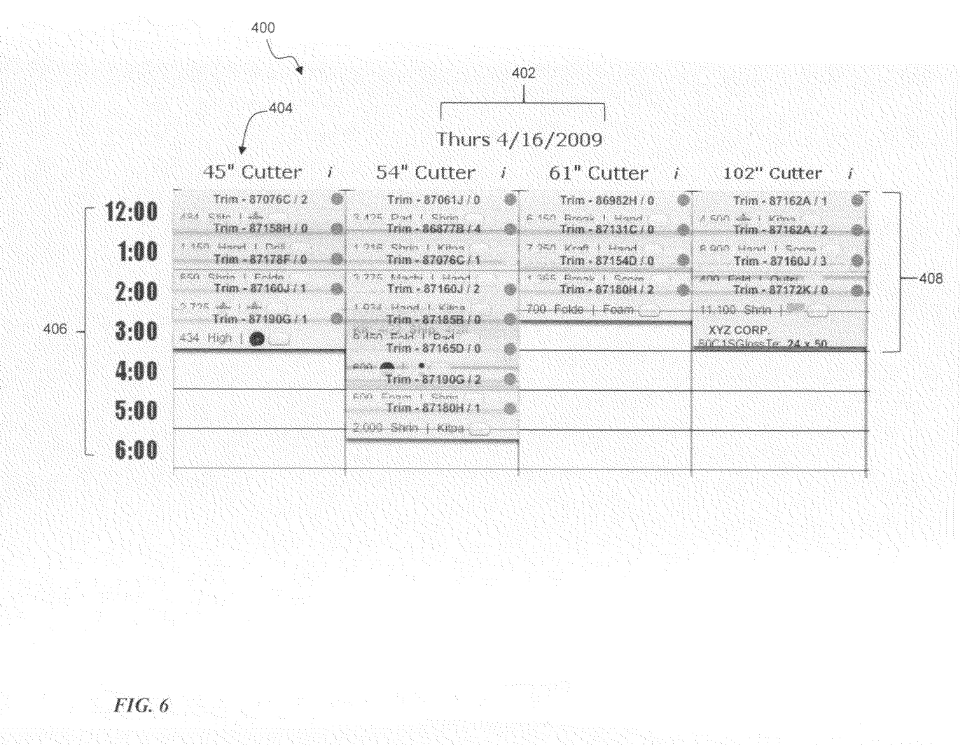

FIG. 6 shows graphic scheduling interface 400 that is vertically oriented by day 402 and a plurality of machines 404 over time 406 showing the visual representation of each days unscheduled task tickets. In this embodiment, task tickets, such as 102″ Cutter task tickets 408, are listed and shown overlapping. This allows a user to view a particular resource's workflow for a particular date and schedule that workflow accordingly. Another advantage is that this allows a user to quickly and visually view a resource's scheduled workflow by date.

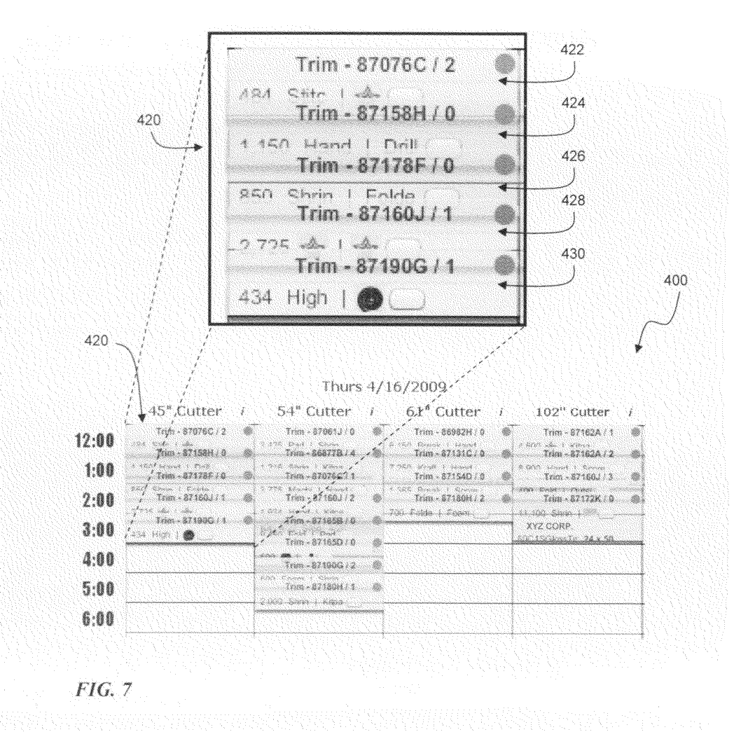

FIG. 7 shows graphic scheduling interface 400 with the 45″ Cutter task tickets 420 enlarged to show the visual overlap tasks scheduled for Thursday Apr. 16, 2009. In this embodiment, task tickets 422, 424, 426, 428, and 430 are visually listed and staggered to allow the user to quickly identify the days required workflow. Each task is scheduled to be completed on the day of Thursday Apr. 16, 2009 on the 45″ Cutter but is not yet scheduled on the resources production workflow by time. In this view, information pertinent to the daily scheduling of a resources workflow may be shown, such as priority indicators to allow managers to quickly view and schedule a resources' daily workflow.

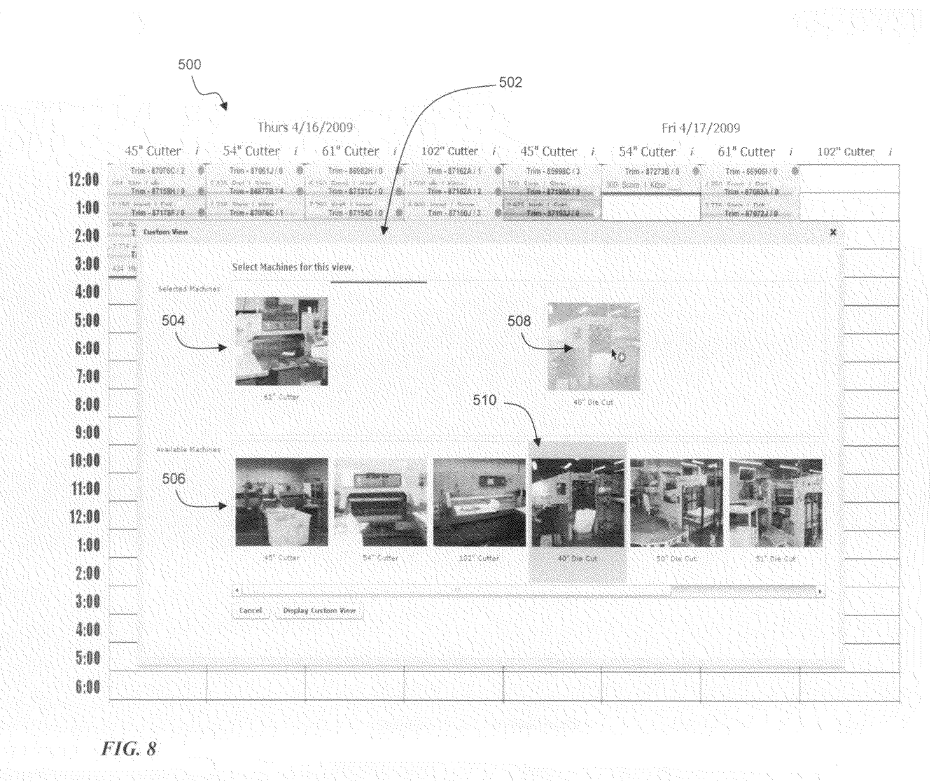

FIG. 8 shows graphic scheduling interface 500 that is vertically oriented by day and machines of the same functionality over time showing custom view 502 which allows users to customize the resources displayed. In this embodiment, a user is able to customize the resources displayed by using custom view 502. Resources selected to be displayed are shown in the selected machines view 504 as selected machines and resources available to be displayed are shown in the available machines view 506 as available machines. Shown, a user has selected the available 40″ Die Cut 510 and moved it to selected machines view 504 as selected 40″ Die Cut 508 according to a drag and drop operation. This is particularly useful for scheduling a task that may be completed by a number of resources or when a particular user is responsible for a number of resources and wishes to view their workflow.

A user's view may be customized and saved. Each user may be required to login to the system, whereby that user's saved display is available. Alternatively, an administrator may create the display that the user may view.

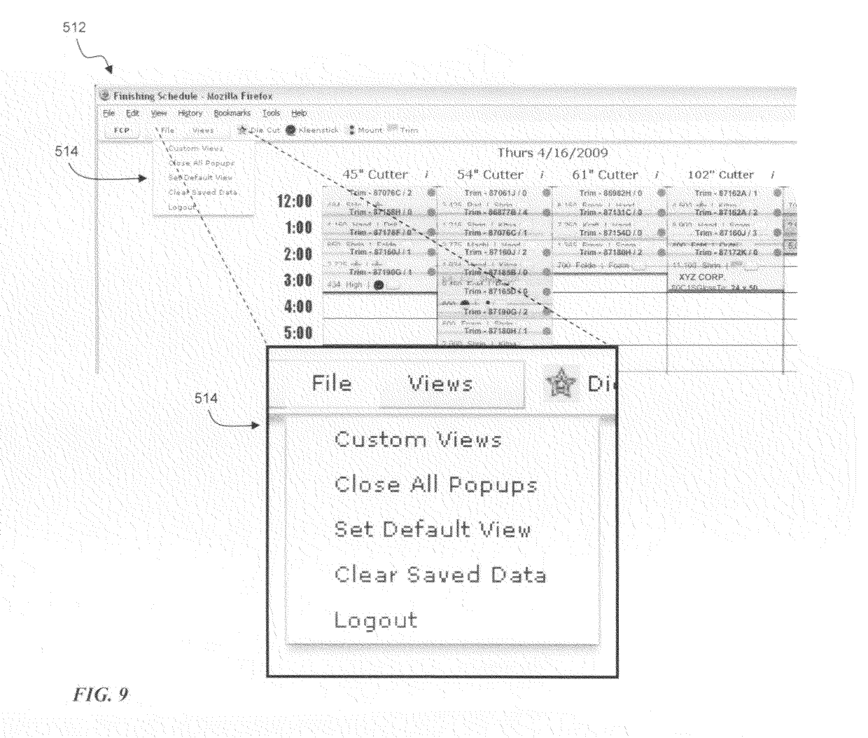

FIG. 9 is a cropped screenshot 512 of an embodiment of the graphical scheduling interface. File tab 514 has been enlarged to show examples of the functional options a user may use to customize the scheduling interface. As shown in file tab 514, the user may create and save a custom view and later retrieve that view by selecting “Custom Views” and set a default view. “Close All Popups” allows a user to close all popup screens, such as those providing additional machine or task details, that have been selected. “Set Default View” allows a user to set the default screen they will automatically initially see after logging on to the system. “Clear Saved Data” allows a user to clear a created schedule. And “Logout” allows a user to logout of the system.

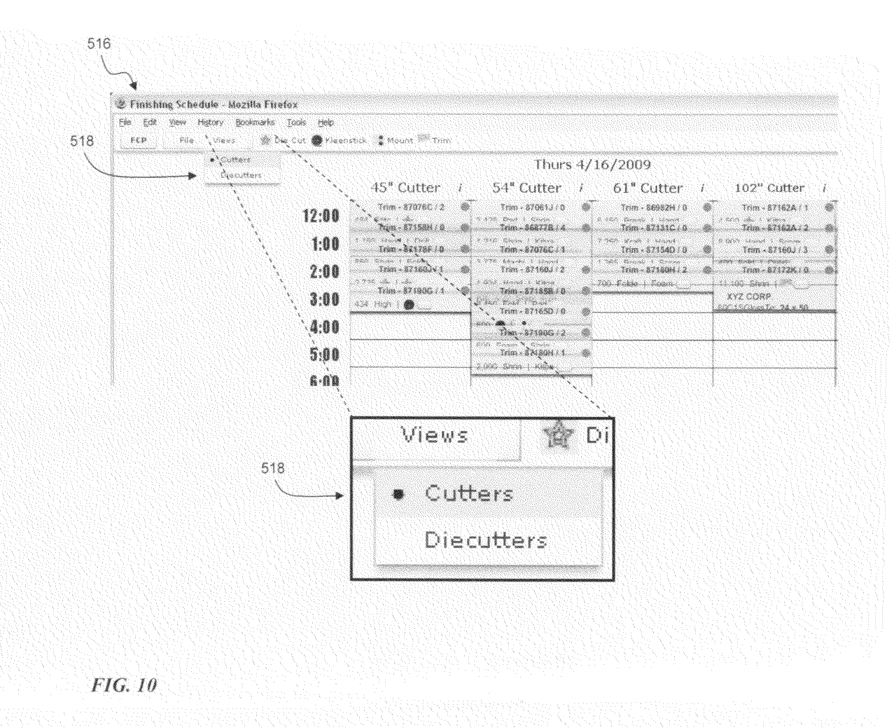

FIG. 10 is a cropped screenshot 516 of an embodiment of the graphical scheduling interface showing an enlarged view of a user's display viewing options. View tab 518 has been enlarged to show examples of the viewing options a user may use to customize the scheduling interface. As shown in views tab 518, a user may view a group of resources together. Here, the resources have been saved according to their functionality and the workflow for the resources assigned as “Cutters” and “Diecutters” are available for display on the scheduling interface. A selection of resources may be grouped and saved for later display by a user or administrator. As shown, the “Cutters” and “Diecutters” are preset display views that provide the user a shortcut to view the workflow of the resources belonging to these particular groups. Alternatively, the workflow for all resources associated with a job may be shown. This allows the user to manipulate a task's schedule to avoid production bottlenecks.

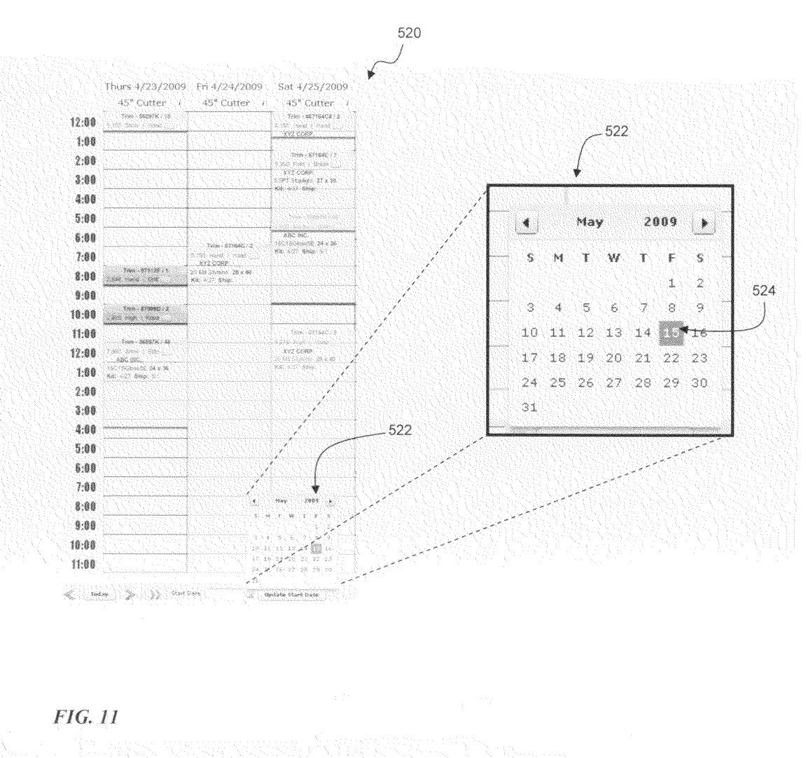

FIG. 11 shows graphic scheduling interface 520 that is vertically oriented by day and machine over time. In this embodiment, a user is able to select the dates to be displayed from date selector 522. Selected date 524 is shown highlighted to reflect that it has been selected for display. This aspect is useful for viewing a resource's, or group of resources, workflow over a period of days. Using this capability, a user may select a day and the display will maximize the number of days and resources shown according to user's screen size entered and saved in screen size input window 580 shown in FIG. 3. By doing so, users may evaluate the use and efficiency of a resource, find bottlenecks and reschedule tasks to avoid them, and find and reschedule tasks in breaks in a resource's use.

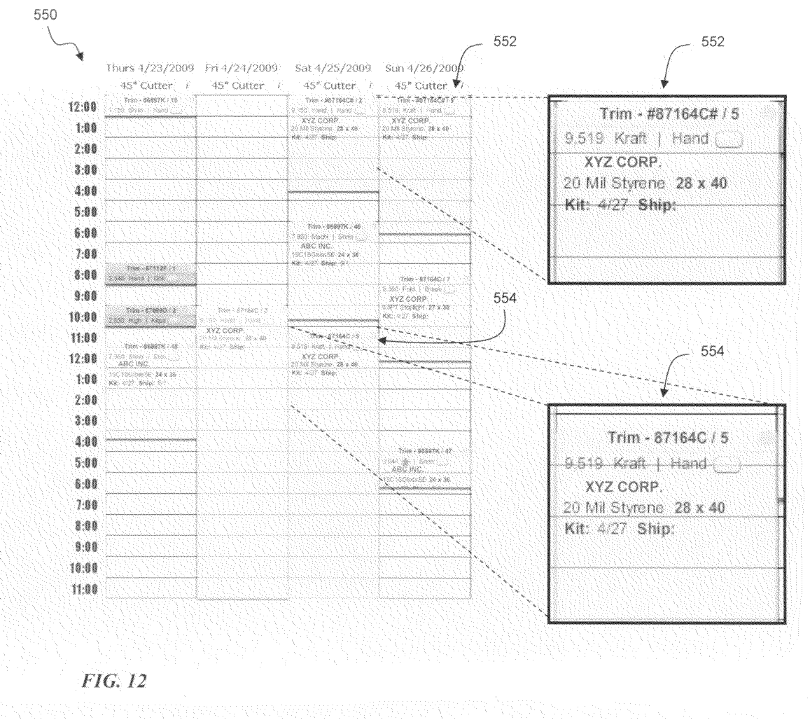

FIG. 12 shows graphic scheduling interface 550 that is vertically oriented by day and machine over time. Trim task ticket 554 and spillover trim task ticket 552 have been enlarged to show the visual and structural connections between a task ticket and a spill over task ticket. Trim task ticket 554 represents a task that takes two production days to complete (in this particular embodiment displaying the production day as beginning at 12 AM) and spillover trim task ticket 552 represents the remainder of the task that must be completed the next day. Visually, trim task ticket 554 has no task closer and remains open through the available time periods. To help the user identify the two tickets as representing the same task, the two tickets may also be the same color. Structurally, trim task ticket 554 and spillover trim task ticket 552 represent the same task and display the same task information and job numbers, although the header of spillover trim task ticket 552 includes the # sign as an indicator that it is a spill over task ticket and does not represent the complete task.

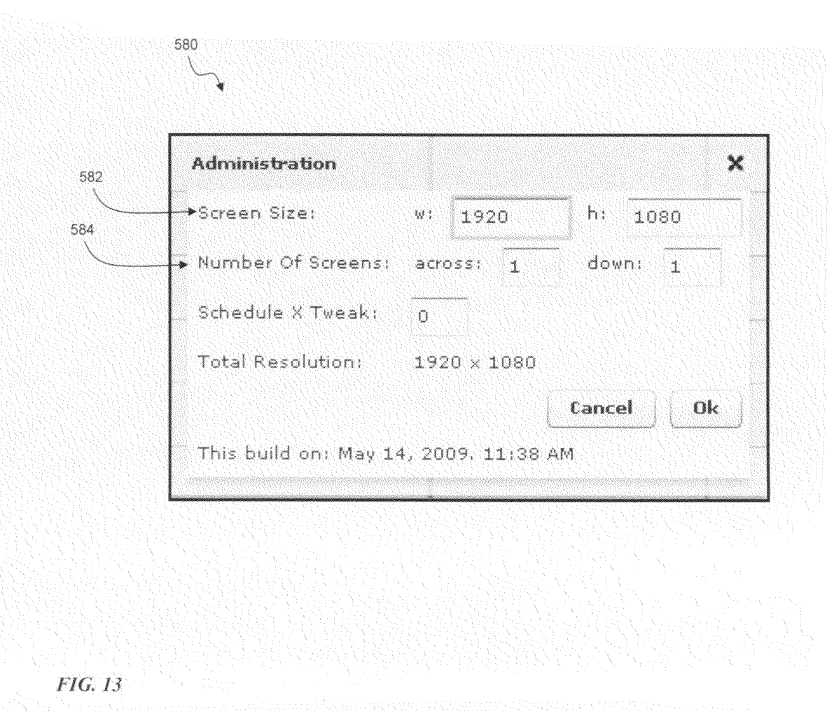

FIG. 13 shows screen size input window 580. Users are able to configure their view by entering the resolution of their monitor by screen size 582 and in the case of multiple monitor/display setups, the grid arrangement 584 (in rows and columns) of those monitors. The system reads the configuration and calculates the proper height and number of days that may be fit into the available monitor space in accordance with the number of resources selected for viewing. This allows a user to use the system on any existing monitor/display setup already installed and allows flexibility when creating a monitor/display setup. The screen configuration may also be tailored to visually fit the schedule across the seams in a multiple monitor setup so that the schedule is displayed in a visually cohesive manner. This is particularly advantageous in multiple monitor displays.

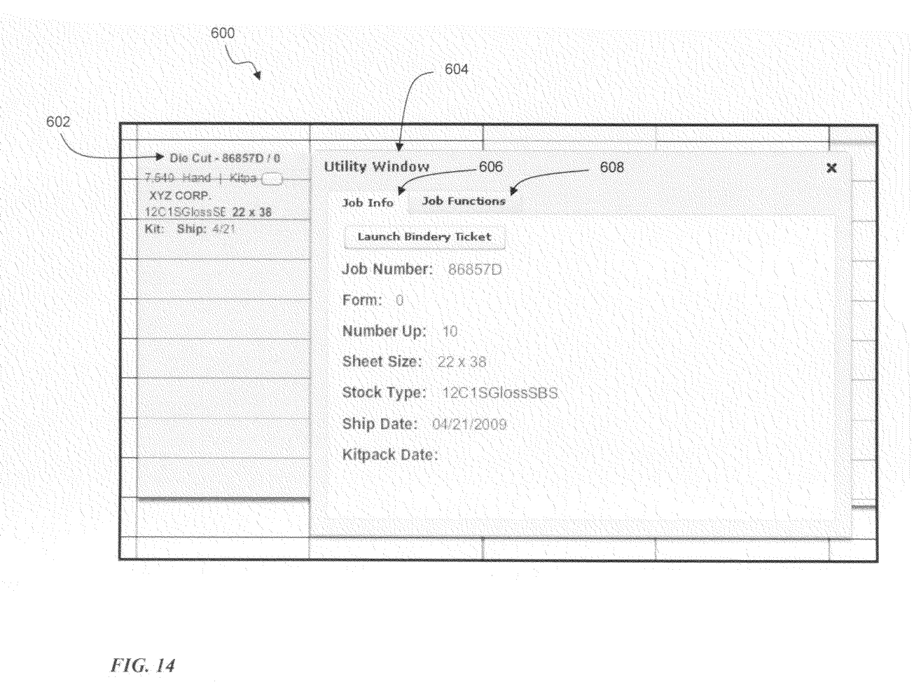

FIG. 14 shows utility window display 600. Utility window 604 displays information about the task represented by task ticket 602. Job info 606 has been selected for view and displays task information such as job number, form, sheet size, and shipping/due dates. Job functions 608 is another view presented by utility window 604 which displays information about other tasks associated with the same job as task ticket 602. In one embodiment, the utility window may be presented by using a mouseover or hover box where utility window 604 appears when the user moves the cursor over a task ticket. Other methods for presenting the utility window include one-click displays, keystrokes, and touch screens.

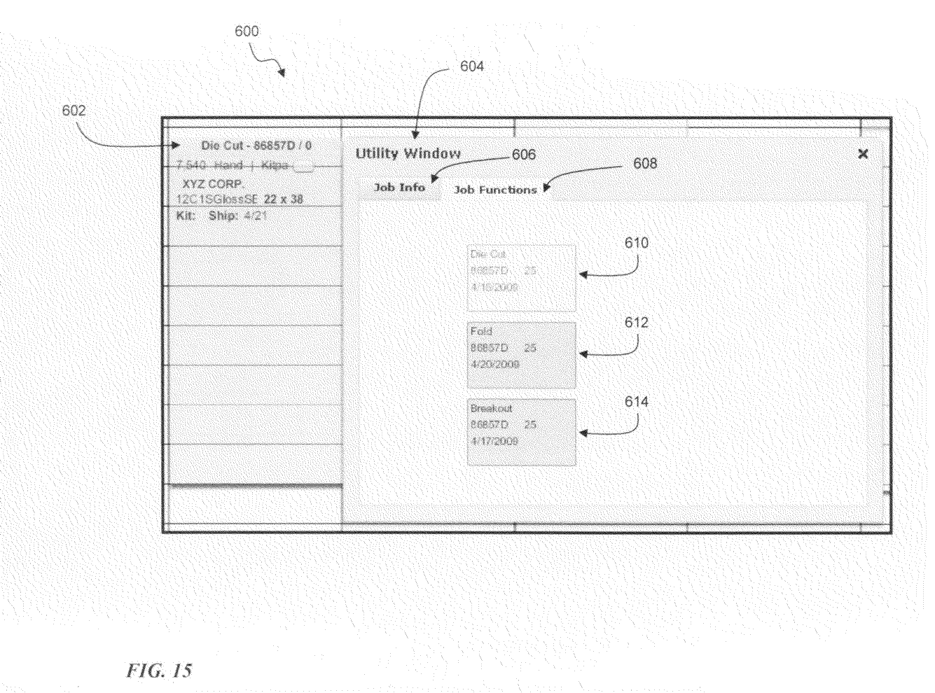

FIG. 15 shows utility window display 600. Utility window 604 displays information about the task represented by task ticket 602. Here, job functions 608 is shown selected. Job functions 608 displays information about other tasks in the chain of operations, here tasks 610, 612, and 614, required to complete the same job associated with task ticket 602. Job functions 608 allows the user a quick visual tool to see a particular tasks relation to a job's chain of operations as a whole. Important information, such as due dates, is displayed in the job functions 608 window about associated tasks 610, 612, and 614.

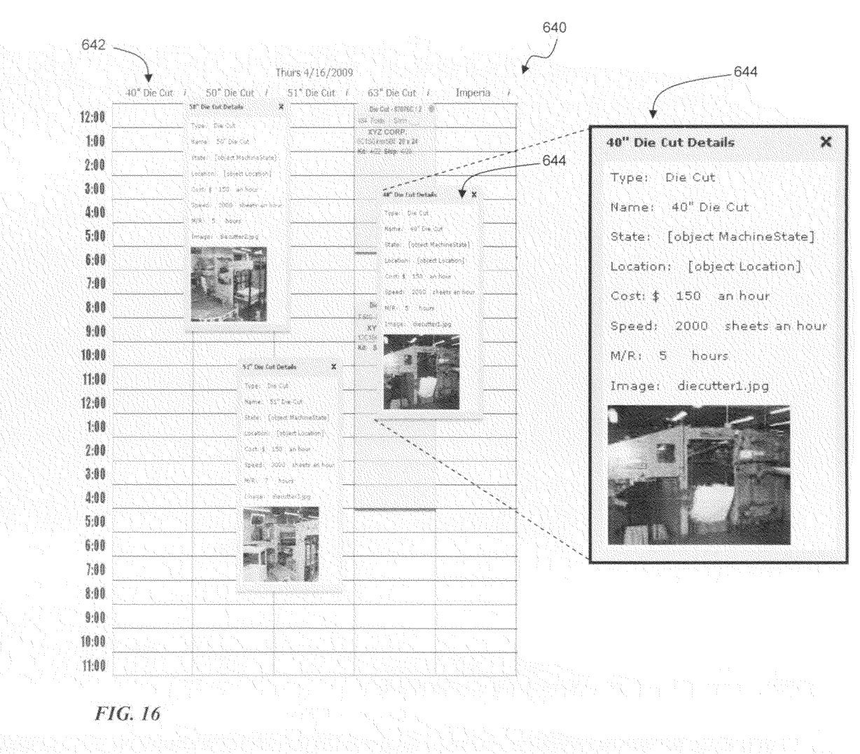

FIG. 16 shows graphic scheduling interface 640 that is vertically oriented by day and machines of the same functionality over time and displaying machine detail windows. Machine details 644 has been enlarged to show the information that may be included in this window. Machine details 644 presents information relating to machine 642 listed on the schedule. Information such as machine location, operating costs, and operating speed are presented to allow a user to properly schedule a task that may be performed by a number of resources. The type of information presented may be customized and saved by a user or administrator. This information may be customized according to the type of resource, the associated task, or the information relevant to a particular user. Machine details 644 is particularly helpful for users scheduling tasks while viewing multiple machines of the same functionality.

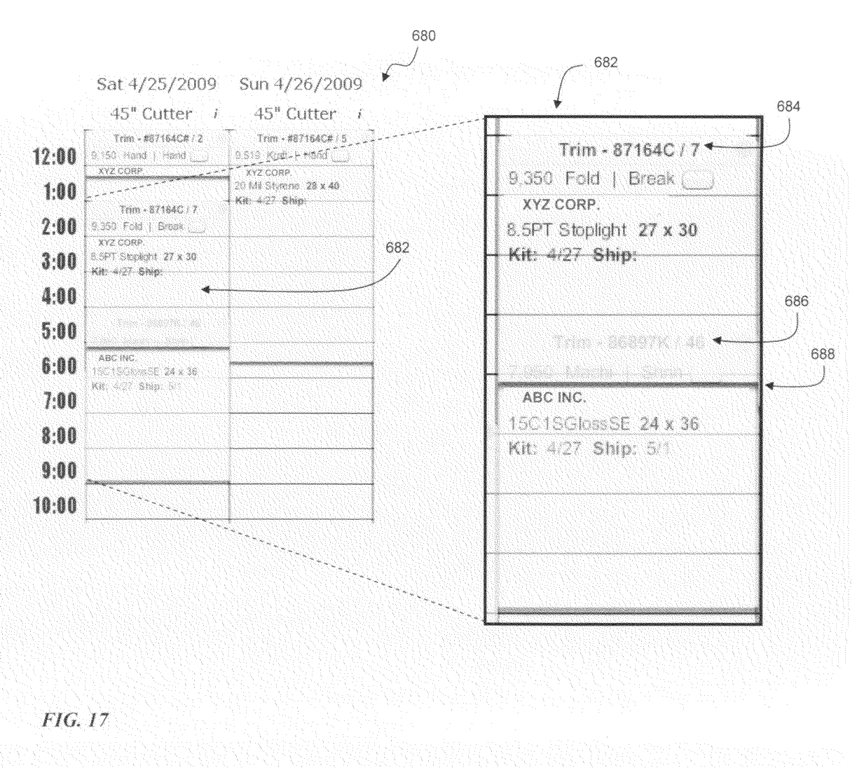

FIG. 17 shows graphic scheduling interface 680 that is vertically oriented by day and machine over time. Overlapping task tickets 682 have been enlarged to show the visual manner in which tasks scheduled during overlapping time periods may be displayed. This may occur when a resource is capable of completing multiple tasks at the same time. Trim task 684 and trim task 686 are scheduled concurrently on the 45″ Cutter on Saturday Apr. 25, 2009 from 5 to 6 PM. This is allowable because the 45″ Cutter is able to perform these two tasks at once. To show this, trim task 686 has been visually placed behind trim task 684. Trim task 684 is completed at 6 PM as designated by task closer 688 which overlaps trim task 686. If the 45″ Cutter could not perform these two tasks concurrently, the schedule would not allow them to be scheduled at the same time.

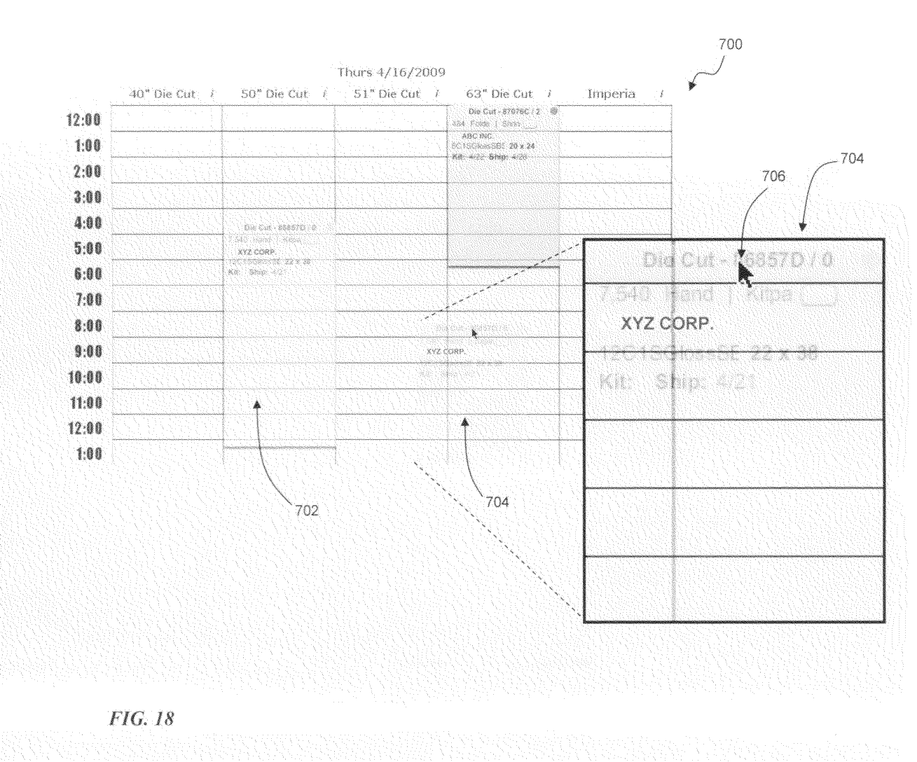

FIG. 18 shows graphical scheduling interface 700 that is vertically oriented by day and machines of the same functionality over time. Task ticket 702 is being moved according to a drag and drop operation, as shown by selected task ticket 704. As shown, this is a valid rescheduling of task ticket 702, meaning that the 63″ Die Cut is able to complete the task associated with task ticket 702. As cursor 706 moves over the 63″ Die Cut workflow, selected task ticket 704 will visually indicate to the user whether that resource is able to complete the task. Alternatively, task ticket 702 may be rescheduled by a touch screen operation.

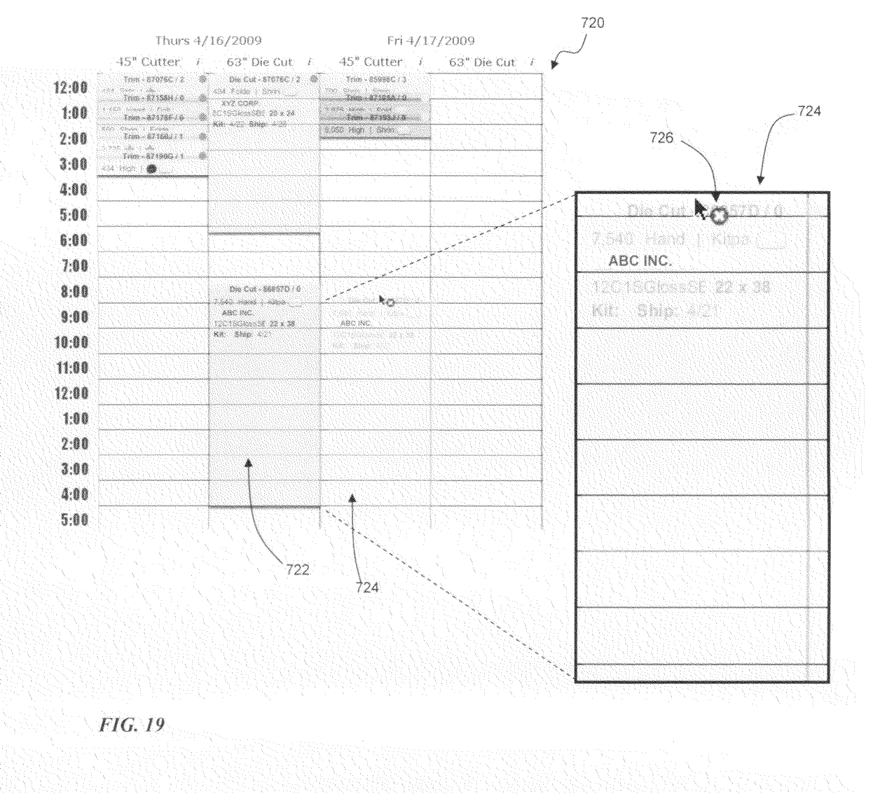

FIG. 19 shows graphical scheduling interface 720 that is vertically oriented by day and machines of the same functionality over time. Here, task ticket 722 is being moved according to a drag and drop operation, as shown by selected task ticket 724, to the 45″ Cutter on Friday Apr. 17, 2009. However, this is not a valid rescheduling of task ticket 722 because the 45″ Cutter cannot complete the task. Cursor 726 is accompanied by a red X to indicate to the user that this is not a valid rescheduling of the task. If a task is dropped or dragged over an invalid resource, the task ticket will indicate to the user that the resource is invalid and that is an invalid scheduling.

A reschedule may be invalid for a number of reasons, including that the selected date is not compatible with the task. In this case, it may be because a task must be completed by a certain date, the job with which the task is associated must be completed by a certain date, or that another task in the associated jobs chain of operations must be completed by a certain date. When a scheduled task ticket is dropped, i.e. the cursor drags the task ticket to the invalid date, the task ticket will indicate that the date is invalid.

In operation, the present disclosure allows a user to schedule a resources workflow in accordance with predefined constraints. Those constraints include task and project rules and restrictions. The workflow is presented as a graphical display where resources are defined along a first axis and time is defined along a second axis. Users are able to customize their view by adding resources and days to the display. Tasks are displayed as task tickets which are movable virtual objects that visually represent the time a resource takes to complete a task. Each task ticket may be scheduled only according to associated constraints stored as data objects in a database. In a preferred embodiment, a vertical orientation where resources are defined along the x-axis and time is defined vertically along the y-axis.

Although the disclosed subject matter has been described in detail, it should be understood that various changes, substitutions, and alterations may be made hereto without departing from the spirit and scope of the invention as defined by the appended claims.

What is claimed is:

1. A system for scheduling resource workflow, comprising:
a task rules database comprising a plurality of rules relating to sequences for performing a plurality of tasks in completing a job, a plurality of rules relating to the association of tasks to a set of resources, a plurality of rules relating to time periods needed for ones of said resources to complete defined tasks, and time requirements relating to the overall completion of a job;
a computer system for accessing said task rules database and storing said task rules database on a computer readable medium; and
a scheduling interface for interfacing a user with said computer system and said task rules database, said scheduling interface comprising
a user-manipulable display for displaying a resource workflow schedule, said user-manipulable display further comprising,
a resource display oriented along a first axis for displaying the use of a particular one of said set of resources;
a time display oriented along a second axis for displaying the time of using said particular one of said set of resources and the duration of using said particular one of said set of resources; and
a plurality of movable task tickets for use by a user in designating said resource and said time and duration for using said resource;
wherein said scheduling interface permits use of said movable task tickets and display of said movable task tickets on said user-manipulable display according to constraints derived from said plurality of rules associating with said resources.

2. The system of claim 1, wherein said first axis comprises a horizontal axis, and said second axis comprises a vertical axis.

3. The system of claim 1, wherein at least one of said movable task tickets may span a plurality of days and further wherein said scheduling interface displays said at least one of said movable task tickets as a visually and structurally connected object.

4. The system of claim 1, wherein the scheduling interface is configured according to the size of the display space entered by the user.

5. The system of claim 1, wherein the scheduling interface displays those resources required for the completion of a particular job.

6. The system of claim 1, wherein the scheduling interface lists a resources task tickets required for completion by date.

7. The system of claim 1, wherein the scheduling interface allows the task tickets to be moved according to a drag and drop operation.

8. The system of claim 1, wherein the scheduling interface allows the resources displayed horizontally along the x-axis to be selected according to a drag and drop operation.

9. The system of claim 1, wherein the scheduling interface displays a selected group of resources horizontally along the x-axis.

10. The system of claim 1, wherein the scheduling interface displays the workflow of a plurality of days of at least one resource horizontally along the x-axis.

11. The system of claim 1, wherein information associated with the task is displayed as a hover box according to a mouseover operation with the associated task ticket.

12. The system of claim 1, wherein the scheduling interface is implemented as a graphical user interface.

13. A computer-implemented method for resource workflow scheduling, the method comprising the steps of:
storing a task rules database in a computer readable medium, said task rules database comprising a plurality of rules relating to sequences for performing a plurality of tasks in completing a job, a plurality of rules relating to the association of tasks to a set of resources, a plurality of rules relating to time periods needed for ones of said resources to complete defined tasks, and time requirements relating to the overall completion of a job;
accessing said task rules database using a computer system;
interfacing a scheduling interface between a user, said computer system and said task rules database, said interfacing further comprising the steps of
displaying a resource workflow schedule on a user-manipulable display comprising the steps of
displaying the use of a particular one of said set of resources on a resource display oriented along a first axis;
displaying the time of using said particular one of said set of resources and the duration of using said particular one of said set of resources a time display oriented along a second axis; and
using a plurality of movable task tickets in designating said resource and said time and duration for using said resource;
permitting use of said movable task tickets and display of said movable task tickets on said user-manipulable display according to constraints derived from said plurality of rules associating with said resources.

14. The method of claim 13, further comprising the step of displaying said first axis as a horizontal axis, and said second axis as a vertical axis.

15. The method of claim 13, further comprising the step of displaying at least one of said movable task tickets to span a plurality of days and further displaying said scheduling interface displays said at least one of said movable task tickets as a visually and structurally connected object.

16. The method of claim 13, wherein the step of displaying a resource workflow is configured according to the size of the display space entered by the user.

17. The method of claim 13, wherein the step of displaying a resource workflow further comprises displaying those resources required for the completion of a particular job.

18. The method of claim 13, wherein the step of displaying a resource workflow further comprises listing a set of resources task tickets required for completion by date.

19. The method of claim 13, further comprising the step of scheduling the task tickets according to a drag and drop operation.

20. The method of claim 13, wherein the step of displaying a resource workflow further comprises displaying a resource horizontally along the x-axis to be selected according to a drag and drop operation.

21. The method of claim 13, wherein the step of displaying a resource workflow further comprises displaying a selected group of resources horizontally along the x-axis.

22. The method of claim 13, wherein the step of displaying a resource workflow further comprises displaying a plurality of days of at least one resource horizontally along the x-axis.

23. The method of claim 13, wherein the step of displaying a resource workflow further comprises displaying information associated with a task as a hover box according to a mouseover operation with the associated task ticket.

24. A computer readable medium comprising a computer-implemented method for resource workflow scheduling, said computer readable medium comprising:
instructions for storing a task rules database in a computer readable medium, said task rules database comprising a plurality of rules relating to sequences for performing a plurality of tasks in completing a job, a plurality of rules relating to the association of tasks to a set of resources, a plurality of rules relating to time periods needed for ones of said resources to complete defined tasks, and time requirements relating to the overall completion of a job;
instructions for accessing said task rules database using a computer system;
instructions for interfacing a scheduling interface between a user, said computer system and said task rules database, said interfacing instructions further comprising
instructions for displaying a resource workflow schedule on a user-manipulable display comprising the steps of
instructions for displaying the use of a particular one of said set of resources on a resource display oriented along a first axis;
instructions for displaying the time of using said particular one of said set of resources and the duration of using said particular one of said set of resources a time display oriented along a second axis; and
instructions for using a plurality of movable task tickets in designating said resource and said time and duration for using said resource; and further
instructions for permitting use of said movable task tickets and display of said movable task tickets on said user-manipulable display according to constraints derived from said plurality of rules associating with said resources.
